(19) United States
(12) Patent Application Publication
(10) Pub. No.: US 2010/0118371 A1
(43) Pub. Date: May 13, 2010

(54) THREE-DIMENSIONAL SPACE SCANNER

(75) Inventors: Back Kue LEE, Gyunggi-do (KR); Se Ho Jung, Gyunggi-do (KR); Hong Ki Kim, Gyunggi-do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/569,144

(22) Filed: Sep. 29, 2009

(30) Foreign Application Priority Data
Nov. 11, 2008 (KR) 10-2008-0111890

(51) Int. Cl. G02B 26/10

(52) U.S. Cl. 359/221.2

(57) ABSTRACT

A three-dimensional space scanner can obtain spatial data by scanning a space around a mobile object not only in the horizontal direction but also in the vertical direction to measure a distance to a surrounding obstacle using a mirror that is driven to rotate as well as to tilt.

### CROSS-REFERENCE TO RELATED APPLICATIONS

This application claims the priority of Korean Patent Application No. 10-2008-0111890, filed on Nov. 11, 2008, in the Korean Intellectual Property Office, the disclosure of which is incorporated herein by reference.

### BACKGROUND OF THE INVENTION

1. Field of the Invention

The present invention relates to a three-dimensional space scanner, and more particularly, to a three-dimensional space scanner which can obtain spatial data by scanning a space around a mobile object not only in the horizontal direction but also in the vertical direction using a mirror that is driven to rotate as well as to tilt.

2. Description of the Related Art

An autonomous mobile (walking) device such as a mobile robot senses a surrounding object and measures a distance from the object using a laser beam, supersonic waves or the like in order to locate its position and determine a moving direction.

Laser range finding is known as a most accurate method for measuring the distance to an object, particularly, by sensing a laser beam reflecting from the object and measuring the time taken for the laser beam to travel to the object and back.

A conventional autonomous mobile device adopting such a laser range finding technique scans a surrounding space using laser beams emitted directly along a two-dimensional horizontal plane. Accordingly, the autonomous mobile device can sense surrounding objects and measure distances from the objects only if the objects are located at a specific height corresponding to a laser emitter.

That is, sensible objects are limited to those onto which the laser beams are emitted and to those which are located at the same horizontal plane of the laser emitter. Thus, it is impossible to scan other ranges and distance information on only a specific horizontal plane can be obtained.

However, while consumer demands on autonomous mobile devices capable of performing more accurate drive and more various operations are increasing, the distance information only on a specific horizontal plane cannot sufficiently ensure safety and functionality.

### SUMMARY OF THE INVENTION

The present invention has been made to solve the foregoing problems with the prior art, and embodiments of the present invention provide a three-dimensional space scanner which can obtain spatial data by scanning a space around a mobile object not only in the horizontal direction but also in the vertical direction using a mirror that is driven to rotate as well as to tilt.

According to an aspect of the present invention, the three-dimensional space scanner may include a rotary drive unit transmitting a rotating force from a rotary motor through a vertical rotary shaft; a mirror holder having a plurality of holder guides extending downwards from an underside thereof, wherein the mirror holder is rotated by the rotating force of the rotary drive unit; a mirror provided to tilt inside the mirror holder and rotating together with the mirror holder; a tilt drive unit coupling with the holder guide to rotate and vertically reciprocate below the mirror holder so as to tilt the mirror connected via a rod; and a vertical drive unit vertically reciprocating the tilt drive unit.

In an exemplary embodiment, the rod may be hinged to one end of the mirror, which tilts depending a distance of vertical displacement of the tilt drive unit.

A range of tilting of the mirror is determined depending on a range of vertical displacement of the rod.

The tilt drive unit may vertically reciprocate along an outer circumference of the rotary motor to a lower end of the mirror holder, with a vertical displacement of the tilt drive unit substantially corresponding to a length of the holder guide.

The tilt drive unit may include a first plate defining therein a penetrating opening and connected to the vertical drive unit to vertically reciprocate; a second plate defining a central hole in a central portion thereof, which allows the rotary motor to pass through, wherein the second plate is fitted into the opening of the first plate and is rotatably coupled with the first plate; and the rod hinged at one end to the second plate and at the other end to the mirror.

The second plate and the rod may rotate inside the opening of the first plate and vertically reciprocate together with the first plate.

The second plate may define a plurality of penetrating guide holes in positions corresponding to the holder guides, such that the holder guides are fitted into and coupled with the guide holes.

The tilt drive unit may further include a guide rod guiding the tilt drive unit to vertically reciprocate along a predetermined path.

The first plate may have a penetrating guide hole in a position corresponding to the guide rod, the guide hole receiving the guide rod.

According to embodiments of the invention, the three-dimensional space scanner can obtain spatial data by scanning a space around a mobile object not only in the horizontal direction but also in the vertical direction using the mirror that is driven to rotate as well as to tilt.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a three-dimensional space scanner according to an exemplary embodiment of the invention;

FIG. 2 is an exploded perspective view of the three-dimensional space scanner shown in FIG. 1;

FIG. 3 is an assembled sectional view illustrating a rotary drive unit and a mirror holder of the three-dimensional spacer shown in FIG. 2;

FIGS. 4A to 4D are enlarged perspective views illustrating a tilt drive unit of the three-dimensional space scanner shown in FIG. 2;

FIGS. 5A and 5B are schematic views illustrating a process of tilting a mirror of the three-dimensional scanner shown in FIG. 3.

### DETAILED DESCRIPTION OF THE EXEMPLARY EMBODIMENTS

A three-dimensional space scanner of the present invention will now be described more fully hereinafter with reference to the accompanying drawings, in which an exemplary embodiment thereof is shown.

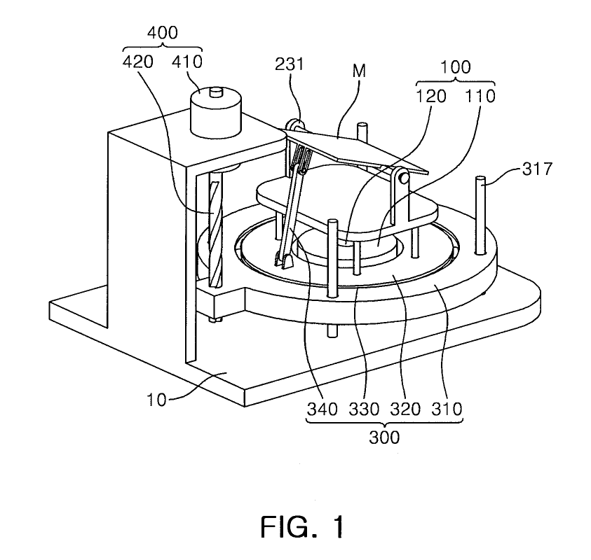

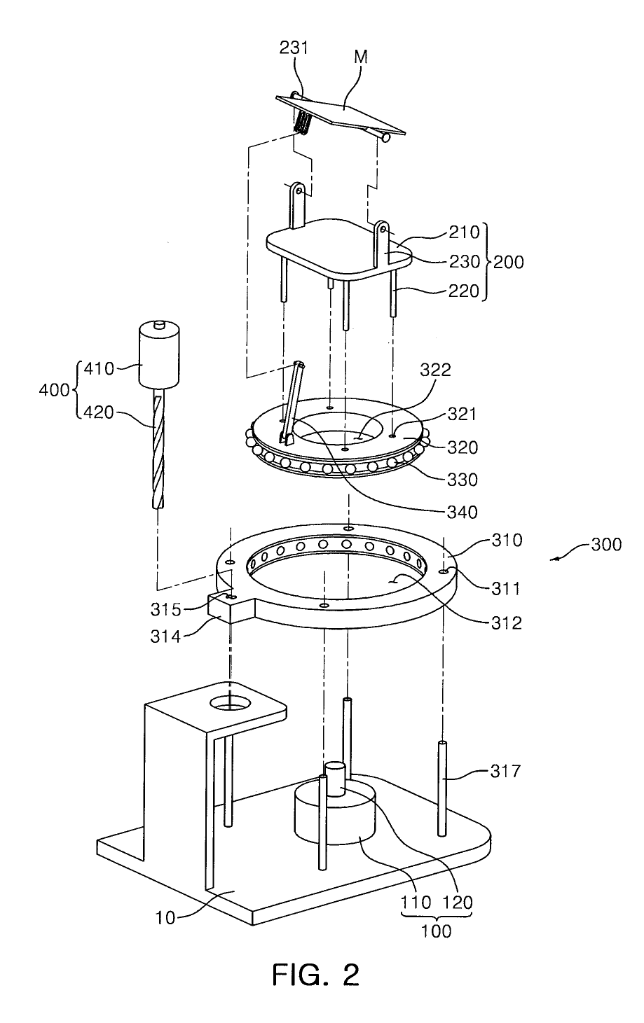

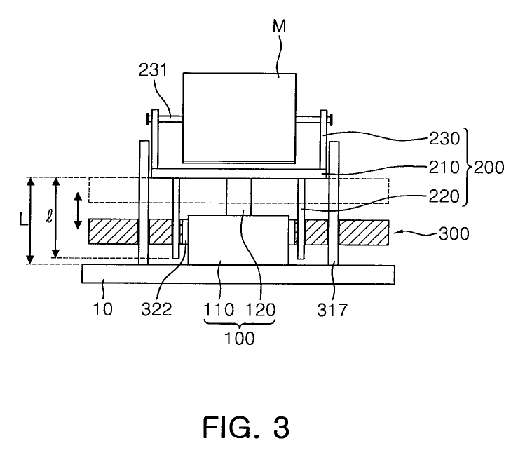

FIG. 1 is a perspective view illustrating a three-dimensional space scanner according to an exemplary embodiment of the invention, FIG. 2 is an exploded perspective view of the three-dimensional space scanner shown in FIG. 1, and FIG. 3 is an assembled sectional view illustrating a rotary drive unit and a mirror holder of the three-dimensional spacer shown in FIG. 2.

As shown in FIGS. 1 and 2, the three-dimensional scanner of the invention includes a rotary drive unit 100, a mirror holder 200, a mirror M, a tilt drive unit 300 and a vertical drive unit 400.

In the autonomous mobile space scanner of the invention, the rotary drive unit 100 is to generate a rotating force for continuously rotating the mirror M for 360 degrees. The rotary drive unit 100 is provided in the lower portion with a rotary motor 110 that rotates a vertical rotary shaft 120. The rotary motor 110 can be housed inside a case for the purpose of protection.

The vertical rotary shaft 120 is coupled at one end with the rotary motor 110 and at the other end with the mirror holder 200 to transmit the rotating force from the rotary motor 110 to the mirror holder 200.

In the meantime, the mirror holder 200 is a rotary member that is axially connected to the vertical rotary shaft 120 to be rotated in a predetermined direction by the rotating force of the rotary drive unit 100.

As shown in the figures, the mirror holder 200 has an angled U-shaped overall configuration with a horizontal portion 210 and sidewalls 230 extending directly vertically from opposite (right and left) ends of the horizontal portion 210. Substantially the central portion of the horizontal portion 210 is axially connected to the vertical rotary shaft 120.

In addition, a plurality of holder guides 220 extend downwards from the underside of the mirror holder 200.

As shown in FIG. 3, the holder guides 220 have a length l to be shorter than the length L of the rotary drive unit (the entire length including the height of the rotary motor and the length of the vertical rotary shaft) in order to prevent an interference between the holder guides 220 and a frame 10 when the mirror holder 200 is rotating. The interference between the holder guides 220 and a frame 10 would otherwise interfere with the rotation of the mirror holder 200.

The holder guides 220 are connected with the tilt drive unit 300 (which will be described later) to rotate the tilt drive unit 300 following the rotation of the mirror holder 200. The holder guides 220 also act as reference coordinates that guide the vertical displacement of the tilt drive unit 300 as well as controlling the range of the vertical displacement.

As a result, the distance of vertical displacement of the tilt drive unit 300 can be acquired through the holder guides 220, and the range of displacement of the tilt drive unit 300 can also be controlled by adjusting the length of the holder guides 220.

On top of that mirror holder 200, the mirror M is provided so as to tilt on a horizontal rotary shaft 231 connecting the right and left sidewalls 230.

Specifically, since the mirror M is hinged along the horizontal rotary shaft 231 that connects one with the other of the sidewalls 230 of the mirror holder 200 while extending across the mirror holder 200, the mirror M can be tilted at a variety of angles without being fixed at a predetermined angle.

The mirror M functions not only to reflect a laser beam emitted from a laser emitter (not shown) to an area around the three-dimensional space scanner but also to receive the laser beam reflecting from an obstacle and the like and reflect the beam again to an optical sensor (not shown).

Thus, the mirror M can rotate together with the mirror holder 200 at a predetermined rate to scan the laser beam at 360 degrees continuously across the areas around the scanner.

In addition, since the mirror M is tilted in a variety of ranges of angle without being fixed to an inclination 45° to scan a surrounding space, it is possible to obtain spatial data including two-dimensional data on a horizontal plane according to a specific height of the related art as well as a vertical distance.

In the meantime, the tilt drive unit 300 acts to rotate and vertically reciprocate below the mirror holder 200, in cooperation with the holder guides 220. Thereby, the tilt drive unit 300 tilts the mirror M connected thereto using a rod 340.

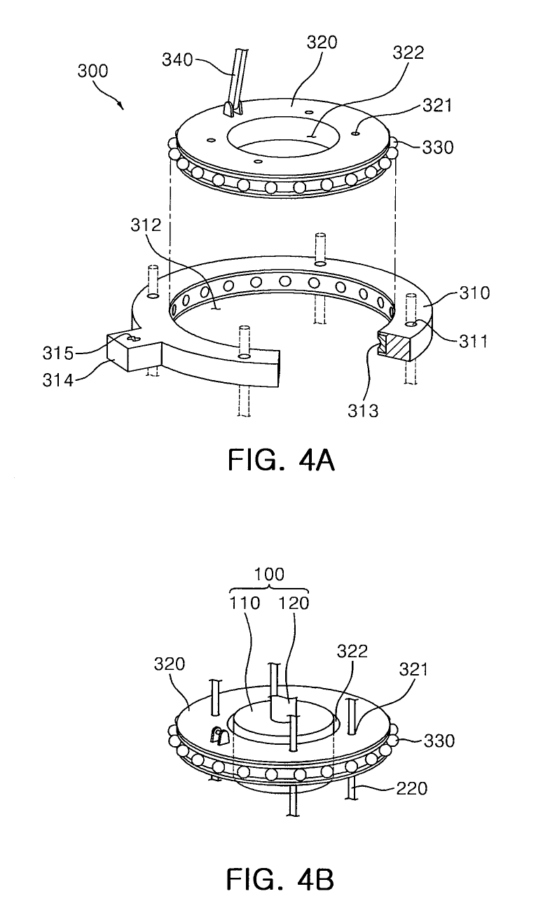

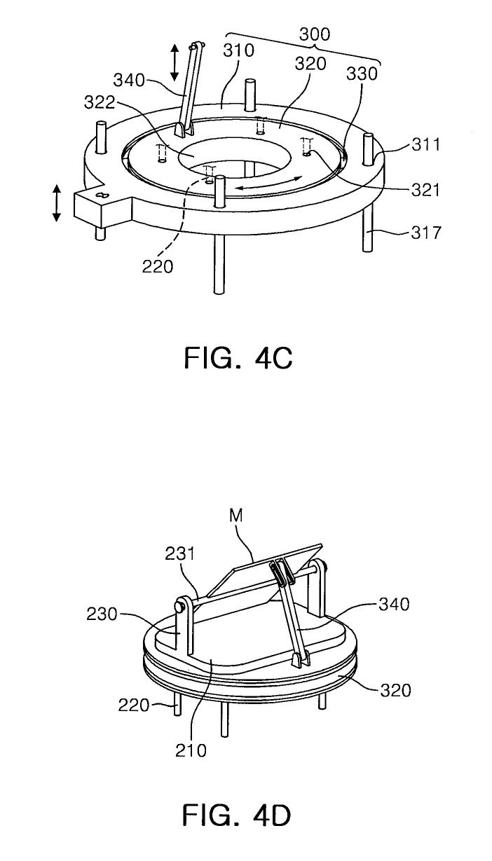

Below, a detailed description will be given of the construction and operation of the tilt drive unit 300 with reference to FIG. 4.

FIGS. 4A to 4D are enlarged perspective views illustrating the tilt drive unit of the three-dimensional space scanner shown in FIG. 2.

As shown in FIGS. 2 and 4A, the tilt drive unit 300 includes a first plate 310, a second plate 320 and the rod 340.

The first plate 310 is connected to the vertical drive unit 400 via a coupling protrusion 314 in the outer circumference thereof and is thus supported by the vertical drive unit 400. The first plate 310 vertically reciprocates using a rotating force generated by the vertical drive unit 400.

While this embodiment of the invention is configured such that the vertical drive unit 400 includes the rotary motor 410 and the rotary shaft 420, the coupling protrusion 314 has a through-hole 315, into which the rotary shaft 420 having teeth is fitted to be meshed with the protrusion 314, and the rotary shaft 420 is rotated in a predetermined direction by the rotating force from the rotary motor 410 so as to vertically reciprocate the first plate 310, this is not intended to be limiting.

The first plate 310 has a penetrating opening 312 therein and a groove 313 formed along the outer circumference of the opening 312.

This construction allows the second plate 320 to be fitted into the opening 312 and be rotatably coupled with the first plate 310.

Here, a bearing 330 can be provided between the groove 313 and the outer circumference of the second plate 320 in order to ensure that the second plate 320 can smoothly rotate.

As shown in FIGS. 3 and 4A, the second plate 320 has a central opening 322 in the central portion thereof such that both the vertical rotary shaft 120 and the rotary motor 110 of the rotary drive unit 100 can pass through the central opening 322 when the second plate 320 vertically moves together with the first plate 310.

With this configuration, as shown in FIG. 4B, when the second plate 320 vertically reciprocates, it can reach the lower end of the mirror holder 200 along the outer circumference of the rotary motor 110 without colliding into the rotary drive unit 100. As an advantageous effect, this can reduce the size of the scanner.

Specifically, the displacement range of the tilt drive unit 300 is limited to the lower side of the mirror holder 200, and the distance of displacement of the tilt drive unit 300 substantially corresponds to the length of the holder guides 220. Therefore, the scanner can be miniaturized by controlling the size of the rotary motor 110 and the vertical rotary shaft 120 of the rotary drive unit 100.

In addition, the second plate 320 has a plurality of penetrating guide holes 321 in positions corresponding to the holder guides 220 of the mirror holder 200 such that the holder guides 220 are fitted into and coupled with the guide holes 321.

Therefore, as shown in FIG. 4C, when the mirror holder 200 rotates, the holder guides 220 allow the second plate 320 and the rod 340 to rotate together with the mirror M connected with the rod 340 inside the opening 312 of the first plate 310.

Since the second plate 320 moves along the holder guides 220 through the guide holes 321 when the first plate 310 vertically reciprocates, the mirror holder 200 is not influenced by the vertical reciprocation of the tilt drive unit 300.

The tilt drive unit 300 can also include guide rods 317 that guide the tilt drive unit 300 to vertically reciprocate along a predetermined path. In this case, the first plate 310 has penetrating guide holes 311 in positions corresponding to the guide rods 317 to receive the guide rods 317.

In addition, as shown in FIG. 4D, the rod 340 is hinged at one end to the second plate 320 and at the other end to the mirror M such that the mirror M tilts depending on the distance of vertical displacement of the tilt drive unit 300.

Particularly, the tilting range of the mirror M is determined depending on the range of vertical displacement of the rod 340. Thus, the tilting range of the mirror M can be controlled by adjusting the distance of vertical displacement of the rod 340.

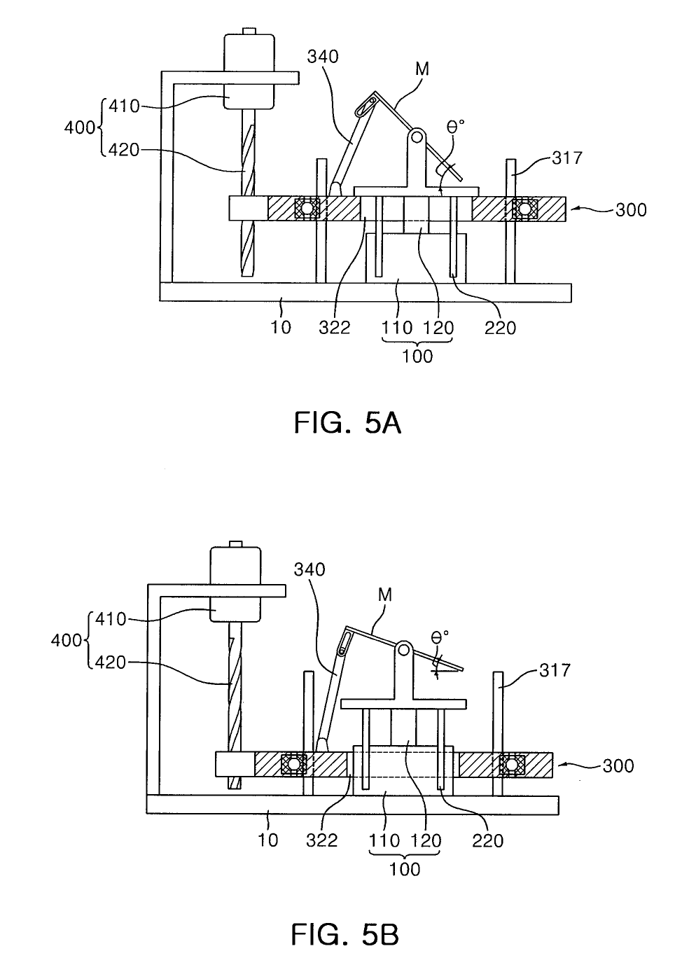

Below, a description will be given of a structure of rotating and tilting the mirror of the invention with reference to FIG. 5.

FIGS. 5A and 5B are schematic views illustrating a process of tilting the mirror of the three-dimensional scanner shown in FIG. 3.

As shown in FIG. 5A, when the first plate 310 is moved upwards along the rotary shaft 420 by a rotating force from the rotary motor 410 of the vertical drive unit 400, the tilt drive unit 300 moves in the right upward direction along the holder guides 220 and the guide rods 317 to reach the upper end of the holder guides 220.

Then, the mirror M is pulled in the right upward direction by the rod 340 up to an inclination θ of 45 degrees or more with respect to the horizon.

In addition, as shown in FIG. 5B, when the first plate 310 is moved downwards along the rotary shaft 420 by the rotating force from the rotary motor 410 of the vertical drive unit 400, the tilt drive unit 300 moves in the right downward direction along the holder guides 220 and the guide rods 317 to reach the lower end of the holder guides 220.

Then, the mirror M is pushed in the right downward direction by the rod 340 up to an inclination θ of 45 degrees or less with respect to the horizon.

The tilting of the mirror M is repeatedly carried out in the range 0°<θ<90° by the first plate 310 that is vertically reciprocating. The tilting range of the mirror M can be controlled by adjusting the range of vertical displacement of the rod 340.

In addition, the rotation of the mirror M can be carried out in the same fashion by the vertical rotary shaft 120 that is continuously rotating.

As set forth above, the invention can obtain spatial data by scanning information on a variety of ranges of angle using a tilting structure of the mirror, which is not fixed to 45 degrees unlike the related art.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A three-dimensional space scanner comprising:
a rotary drive unit transmitting a rotating force from a rotary motor through a vertical rotary shaft;
a mirror holder having a plurality of holder guides extending downwards from an underside thereof, wherein the mirror holder is rotated by the rotating force of the rotary drive unit;
a mirror provided to tilt inside the mirror holder and rotating together with the mirror holder;
a tilt drive unit coupling with the holder guide to rotate and vertically reciprocate below the mirror holder so as to tilt the mirror connected via a rod; and
a vertical drive unit vertically reciprocating the tilt drive unit.

2. The three-dimensional space scanner of claim 1, wherein the rod is hinged to one end of the mirror, which tilts depending a distance of vertical displacement of the tilt drive unit.

3. The three-dimensional space scanner of claim 2, wherein a range of tilting of the mirror is determined depending on a range of vertical displacement of the rod.

4. The three-dimensional space scanner of claim 1, wherein a range of tilting of the mirror is determined depending on a range of vertical displacement of the rod.

5. The three-dimensional space scanner of claim 1, wherein the tilt drive unit vertically reciprocates along an outer circumference of the rotary motor to a lower end of the mirror holder, with a vertical displacement of the tilt drive unit substantially corresponding to a length of the holder guide.

6. The three-dimensional space scanner of claim 1, wherein the tilt drive unit includes:
a first plate defining therein a penetrating opening and connected to the vertical drive unit to vertically reciprocate;
a second plate defining a central hole in a central portion thereof, which allows the rotary motor to pass through, wherein the second plate is fitted into the opening of the first plate and is rotatably coupled with the first plate; and
the rod hinged at one end to the second plate and at the other end to the mirror.

7. The three-dimensional space scanner of claim 6, wherein the second plate and the rod rotate inside the opening of the first plate and vertically reciprocate together with the first plate.

8. The three-dimensional space scanner of claim 6, wherein the second plate defines a plurality of penetrating guide holes in positions corresponding to the holder guides, such that the holder guides are fitted into and coupled with the guide holes.

9. The three-dimensional space scanner of claim 6, wherein the tilt drive unit further includes a guide rod guiding the tilt drive unit to vertically reciprocate along a predetermined path.

10. The three-dimensional space scanner of claim 9, wherein the first plate has a penetrating guide hole in a position corresponding to the guide rod, the guide hole receiving the guide rod.
